(19) United States
(12) Patent Application Publication
(10) Pub. No.: US 2024/0286112 A1
(43) Pub. Date: Aug. 29, 2024

(54) Methods of Making Metal Organic Frameworks with Low-Connectivity and Increased Thermal Stability

(71) Applicant: ExxonMobil Technology and Engineering Company, Annandale, NJ (US)

(72) Inventors: Joseph M. Falkowski, Hampton, NJ (US); Mary S. Abdulkarim, Palisades Park, NJ (US); Julie J. Seo, Clinton, NJ (US)

(21) Appl. No.: 18/572,045

(22) PCT Filed: Jun. 23, 2022
(86) PCT No.: PCT/US2022/034742

§ 371 Date: Dec. 19, 2023

Related U.S. Application Data
(60) Provisional application No. 63/317,582, filed on Mar. 8, 2022.
(60) Provisional application No. 63/296,178, filed on Jan. 4, 2022.
(60) Provisional application No. 63/202,856, filed on Jun. 28, 2021.

(51) Int. Cl. B01J 20/22

(52) U.S. Cl. CPC B01J 20/226

(57) ABSTRACT

Provided herein are post-synthesis methods of thermally stabilizing a metal-organic framework having defects that decomposes after about 12 hours at a first temperature. The methods include contacting the metal-organic framework with a stabilizing solution to provide a treated metal-organic framework. The treated metal-organic framework is thermally stable after 12 hours at a second temperature at least about 50° C. greater than the first temperature. Also, the treated metal-organic framework has a PXRD pattern that is substantially the same as the PXRD pattern of the untreated metal-organic framework. Provided herein are also post-synthesis methods to improve CO₂ adsorption of metal-organic frameworks. Provided herein are also modified EMM-71 metal-organic frameworks.

### CROSS REFERENCE TO RELATED APPLICATIONS

The present application claims priority to and the benefit of U.S. Provisional Application No. 63/317,582 filed on Mar. 8, 2022, of U.S. Provisional Application No. 63/296,178 filed on Jan. 4, 2022, and of U.S. Provisional Application No. 63/202,856, filed on Jun. 28, 2021, which are hereby incorporated by reference in their entirety.

### FIELD

The present disclosure relates to post-synthesis treatments of metal-organic frameworks to increase their thermal stability. The present disclosure also relates to a post-synthesis treatment of metal-organic frameworks to improve their CO₂ adsorption. The present disclosure further relates to metal-organic frameworks comprising non-framework metal cation species.

### BACKGROUND

Instability of metal-organic frameworks is alleviated through the incorporation of trivalent metals such as aluminum, chromium and iron or tetravalent metals such as zirconium, hafnium and titanium. The resulting high degree of connectivity between metal clusters and linkers permits formation of defects without the collapse of the overall structure or loss of chemical stability. The defects can serve as catalytically active sites or as sites for anchoring other elements and can be beneficial for mass and proton transport. Increasing amounts of defects in the metal-organic framework, however, decreases thermal stability of the metal-organic framework. Therefore, the utility of the metal-organic framework having defects in higher temperature environments is diminished.

### SUMMARY

Provided herein are post-synthesis methods of thermally stabilizing a metal-organic framework having a plurality of defects comprising the steps of: (a) providing the metal-organic framework, wherein the metal-organic framework has a first PXRD pattern and decomposes after about 12 hours at a first temperature; and (b) contacting the metal-organic framework with a stabilizing solution to provide a treated metal-organic framework, wherein the treated metal-organic framework has a second PXRD pattern substantially the same as the first PXRD pattern and the treated metal-organic framework is thermally stable at a second temperature after 12 hours at least about 50° C. greater than the first temperature.

Also provided are methods of making a metal-organic framework having improved CO₂ adsorption comprising contacting a metal-organic framework with metal cations and fluoride ions, for instance in the form of a metal fluoride, to produce a treated metal-organic framework comprising a non-framework cationic metal species and fluoride.

Also provided are metal-organic frameworks comprising at least one non-framework cationic metal species selected from the group consisting of lithium, cesium, nickel, cobalt, copper, potassium, silver, and mixtures thereof.

These and other features and attributes of the disclosed methods and systems and their advantageous applications and/or uses will be apparent from the detailed description of which follows.

### BRIEF DESCRIPTION OF THE DRAWINGS

To assist those of ordinary skill in the relevant art in making and using the subject matter hereof, reference is made to the appended drawings, wherein:

FIG. 1 shows the powder X-ray diffraction patterns of the materials prepared in Examples 1, 2 and 3.

FIG. 2 shows the powder X-ray diffraction patterns of the materials prepared in Example 5.

FIG. 3 shows the powder X-ray diffraction patterns of the materials prepared in Example 6.

FIG. 4 shows the powder X-ray diffraction patterns of the materials prepared in Example 7.

FIG. 5 shows the powder X-ray diffraction patterns of the materials prepared in Examples 9 and 10.

FIG. 6 shows the powder X-ray diffraction patterns of UiO-66 samples calcined with and without NH₄F as described in Example 12.

FIG. 7 shows the powder X-ray diffraction patterns of EMM-71 samples, first treated with either formic acid or hydrochloride acid, and calcined in the presence of ammonium fluoride from temperature of 300° C. to 450° C. in 50° C. increments as described in Example 13.

FIG. 8 shows the nitrogen adsorption isotherms of the EMM-71 samples treated with fluoride sources and calcined, as detailed in Example 13.

FIG. 9 shows the powder X-ray diffraction patterns of the EMM-71 samples treated with either formate or HCl (i.e., EMM-71-Formate and EMM-71 HCl of respectively Examples 1 and 2), and then subsequently treated with either ammonium fluoride or ammonium chloride and heat treated at 300° C. for four (4) hours, as detailed in Example 13.

FIG. 10 shows the powder X-ray diffraction patterns of EMM-71 samples, both formic acid and hydrochloric acid-treated (i.e., EMM-71-Formate and EMM-71 HCl of respectively Examples 1 and 2), and calcined in the presence of different weight percent lithium fluoride in accordance with Example 14.

FIG. 11 shows density functional theory (“DFT”) calculations depicting the difference in total internal energy of various acids and decarboxylated products.

FIG. 12 shows the powder X-ray diffraction patterns of EMM-71 samples after treating with various mixtures (i.e., isobutyric acid (or isobutanoic acid), n-butanoic acid, formic acid, sodium formate, and HCl), as detailed in Example 15. Patterns were collected at temperatures between 25° C. and 350° C.

FIG. 13 shows the powder X-ray diffraction patterns of Zr-Fumarate (a fumarate analogue of UiO-66) before and after NH₄F treatment; patterns were collected at temperatures between 25° C. and 450° C., as detailed in Example 16.

FIG. 14 shows the powder X-ray diffraction patterns of Zr-Fumarate having a fumaric acid to zirconium ratio of 0.91 before and after NH₄F treatment; patterns were collected at temperature between 25° C. and 450° C., as detailed in Example 16.

FIG. 15 shows the powder X-ray diffraction patterns of EMM-71 before and after the post synthesis treatments of Example 18 at temperatures ranging from 100° C. to 500° C.

FIG. 16 is a plot of the temperature programmed X-ray diffraction experiment of Example 19.

### DETAILED DESCRIPTION

Before the present compounds, components, compositions, and/or methods are disclosed and described, it is to be understood that unless otherwise indicated this disclosure is not limited to specific compounds, components, compositions, reactants, reaction conditions, ligands, catalyst structures, MOF structures, or the like, as such may vary, unless otherwise specified. It is also to be understood that the terminology used herein is for the purpose of describing particular aspects only and is not intended to be limiting.

All numerical values within the detailed description are modified by “about” the indicated value, and take into account experimental error and variations that would be expected by a person having ordinary skill in the art.

As used herein, the term “divalent” refers to an oxidation state of the divalent cation and not whether it is part of an overall charged molecule (for example, ZnCl₂ dissolved and not dissociated).

As used herein, the term “-valent” refers to an oxidation state of a cation and not whether it is part of an overall charged molecule (i.e., divalent can refer to both charged species such as Zn²⁺(H₂O)₆ as well as neutral compounds such as ZnEt₂).

As described herein, samples were analyzed on either a Panalytical XPert Pro powder X-ray diffractometer fitted with an Anton Paar HTK-16N environmental stage equipped with a Pt-strip heater, or a Bruker D8 Endeavor powder X-ray diffractometer. All samples were analyzed as is and without any further grinding. All X-ray patterns collected at elevated temperatures were collected during a temperature programmed ramp described in Example 18 and FIG. 16. Each scan was ˜20 minutes in length ranging from 2-60° 2θ with 0.02° step sizes. The portions of the temperature program that correspond to measurements are represented in FIG. 16 as dashed lines.

As used herein, a PXRD pattern is substantially the same as another PXRD pattern when the PXRD patterns have at least 5 major reflections in common and the principal reflection (most intense in starting material) is attenuated in peak height by no more than 50% or peak width (measured as the width at half maximum) increases by no more than a factor of 2.

Lost reflections in a second PXRD pattern may be due to impurities in the metal-organic framework having a first PXRD pattern. For example, undissolved NH₄F or other species may be present in the powder diffraction pattern initially resulting in peaks not observed in untreated MOF sample. These peaks can disappear upon heating due to the volatilization of the species. In this case, a non-MOF component of the mixture is lost, but the peaks representing the framework remain. Alternatively, in some cases, defects are removed through this process. In the case of UiO-66/EMM-71, the peaks at 4 and 6° 2θ will be attenuated during calcination after treatment of ammonium fluoride. The fact that only these peaks are attenuated highlights that they only result from the defect structure and not from the bulk of the MOF. Generally, one can assume the loss of select peaks from a pattern indicate the loss of defect structure or impurities.

As used herein, a stabilizing solution is a flowing agent, a chemical agent, or a purifying agent and can have more than one function in the stabilizing solution.

As previously described in U.S. provisional patent application No. 63/202,856, the EMM-71 metal-organic framework generally has a surface area between about 1100 m²/g and 2700 m²/g, a porosity of between about 0.45 cc/g and 1.1 cc/g, and a relative intensity equal to or greater than 0.35. In an aspect, these metal-organic frameworks generally have a relative ratio of peak width at half maximum (of the (110) reflection relative to the (111) reflection) of less than 3. The relative ratio of peak width at half maximum is equal to the width of the peak at half of the height. In addition, as described herein, the EMM-71 metal-organic framework can have a divalent cation in an amount less than or equal to 5.0 wt. %.

Metal-organic frameworks (“MOFs”) are constructed with a three-dimensional assembly of metal ions (metal clusters) and organic ligands. Metal-organic frameworks comprise organic linkers (referred to also as “ligands”) that bridge metal nodes (referred to as “secondary building units” or “SBUs”) through coordination bonds and can self-assemble to form a coordination network. Tunable topologies, either through isoreticular expansion or functionalization of the organic linker/metal node, make metal-organic frameworks customizable for various different applications ranging from catalytic transformations to biomedical applications. Having ordered structure and tunability with high pore volume, metal-organic frameworks are suitable as catalysis and batteries and in processes such as gas storage and mass transportation, separation (gas adsorption), purification and heating/cooling.

Stability of a metal-organic framework (“MOF”) is attributable to strong interactions between ions of similar polarizability (i.e., carboxylates and high (>3+) valent, hard metal cations or imidazolates and low (2+) valent, soft metal cations). Initially, stable metal-organic frameworks were relegated to phthalate-based MOFs derived from trivalent cations, namely Al³⁺, Fe³⁺, and Cr³⁺. Subsequently, other multivalent cations such as Zr⁴⁺, Hf⁴⁺, or Ti⁴⁺ were employed to provide robust frameworks. One exemplary metal-organic framework having multivalent cations is the metal-organic framework UiO-66. Cavka, J. H. et al., (2008) “A New Zirconium Inorganic Building Brick Forming Metal Organic Frameworks with Exceptional Stability,” J. Am. Chem. Soc., v.130(42), pp. 13850-13851. At the time of its discovery, UiO-66 had the highest connectivity of any known metal-organic framework.

UiO-66 has been synthesized though various synthetic pathways, primarily solvothermal. The original metal-organic framework UiO-66 did not have open metal sites intrinsic to the crystal structure nor did the organic ligand contain sites for further functionalization. Prior art synthetic conditions include a reaction of a zirconium salt (a chloride or oxychloride) with a linear dicarboxylic acid. An early version of UiO-66 was made with terephthalic acid. Functionalized derivatives as well as isoreticular analogs resulted (i.e., those comprised of longer linear diacids such as 4,4′-biphenyldicarboxylic acid). Most common were high-boiling aprotic solvents, often utilizing N,N-dimethylformamide (“DMF”).

To enhance adsorption and catalytic properties of metal-organic frameworks, defects were incorporated into the metal-organic framework during synthesis. The defects are in the form of an organic linker defect or a missing node defect or both. A high degree of connectivity between metal clusters and linkers permits formation of defects at high concentrations without the collapse of the overall structure. The missing node defect (the removal of clusters) leaves meso-scale cavities to provide more open hierarchical pore structures that are beneficial for mass and proton transportation. Furthermore, under-coordinated metal ions serve as catalytically active sites or anchoring sites for other active elements. The degree of defects is characterized by comparing the integrated intensity of the broad defect region (corresponding to the aggregate integrated intensity of the (100) and (110) reflections) and dividing this integrated value by the average of the intensities of certain reflections (i.e., the (111), (200), and (600) reflections).

The utility of node defects in both adsorption and catalytic applications is considerable. For grafted catalytic sites, defects are capped with catalytic moieties to provide additional functionality. For separation applications, larger defects offer enhanced selectivity for multi-ring naphthene separation and/or selective binding of multi-ring naphthene through enhance diffusional characteristics. However, defects can impact the mechanical and physical properties of a metal-organic framework. Therefore, to maintain a well-defined and tunable structure, during the synthesis of the MOF, control of defect formation is essential in achieving desired MOF properties.

In addition, as the defect content in the metal-organic framework increases, thermal stability can decrease. For example, for UiO-66 to be used in a high temperature process, a nearly defect-free material is required. However, this is at odds with process parameters that require higher pore volumes.

As described in Examples 12 to 19 herein, we discovered that the thermal stability of defective metal-organic frameworks, e.g., the zirconium metal-organic framework EMM-71 (which can be described as fully defective UiO-66), is less than the thermal stability of non-defective metal-organic frameworks, e.g., UiO-66. Higher temperature processes demand a solution to this problem. As presented herein, the present post-synthesis treatment methods can increase the thermal stability of metal-organic frameworks having defects, such as Zr-based EMM-71 material.

In a first aspect, the present methods of thermally stabilizing a metal-organic framework are performed post-synthesis. The methods comprise the steps of: (a) providing a metal-organic framework having a plurality of defects and a first PXRD pattern; and (b) contacting the metal-organic framework with a stabilizing solution to provide a treated metal-organic framework having a second PXRD pattern. As described herein, the metal-organic framework decomposes after about 12 hours at a first temperature. However, the treated metal-organic framework is thermally stable after 12 hours at a second temperature at least about 50° C. greater than the first temperature and the second PXRD pattern is substantially the same as the first PXRD pattern.

In an embodiment, at least 5 reflections of the first PXRD pattern are present in the second PXRD pattern. In an embodiment, intensity of the reflections of the first PXRD pattern are substantially the same as in the second PXRD pattern.

In an embodiment, the metal-organic framework has a cubic structure (where structure refers to Bravais lattice type).

In an embodiment, the metal-organic framework comprises a plurality of metals selected from aluminum, iron, zirconium, titanium and/or hafnium, in particular, the metal-organic framework comprises metal nodes of zirconium, titanium and/or hafnium. In an embodiment, the metal-organic framework comprises Zr₆₋ₓM, metal nodes where M can be hafnium or titanium, or Zr₆ metal nodes. In a further embodiment, the metal-organic framework is a zirconium metal-organic framework or a zirconium-based metal-organic framework further comprising hafnium.

In an embodiment, the metal-organic framework is selected from EMM-71, UiO-66, UiO-67, UiO-68, MOF 808, zirconium fumarate, or NU 1000, in particular EMM-71.

In an embodiment, the stabilizing solution comprises fluoride ions. The source of fluoride ions may for instance be selected from the group consisting of ammonium fluoride and/or alkali metal fluorides, such as lithium fluoride, cesium fluoride, sodium fluoride, potassium fluoride, and mixtures thereof, in particular ammonium fluoride and/or lithium fluoride. Without wishing to be bound by theory, it is believed that post-treatment with ammonium fluoride provides stability not necessarily through defect capping with Fions but through structure rearrangement. Indeed, the present inventors noticed that using ammonium fluoride caused the materials to lose at least part their defects, producing a higher overall thermal stability, while stability was improved but the defects were not observed to be lost after post-treatment with alkali metal fluoride(s). The amount of fluoride ions source may range from e.g., about 0.5 up to about 50 wt. % relative to the MOF, such as from about 1 to about 30 wt. %, for instance about 1, 5, 10, 15 or 20 wt. %. The amount of fluoride ions may range from about 0.5 to 20 mol equivalents relative to MOF (assuming a MOF molecular weight of 1550 g/mol). Contacting of the MOF with the source of fluoride ions may take place under any suitable conditions, for instance by simple contacting at room temperature or under optional heating up to calcining temperature such as, e.g., 250° C., optionally under mixing or stirring or mulling of the mixture (e.g., slurry). The contacting period may be any suitable time, e.g., from 30 seconds to 12 hours, such as from 1 or 10 minutes up to 1 or 2 or more hours.

In an alternative embodiment, the stabilizing solution comprises at least one acid selected from the group consisting of carboxylic acids, sulfonic acids, sulfuric acid, phosphonic acids, and mixtures thereof, preferably a carboxylic acid or sulfuric acid. For example, the carboxylic acid may be selected from formic acid, acetic acid, benzoic acid, propionic acid, butanoic acid, or isobutanoic acid. The sulfonic acid may be selected from methylsulfonic acid, ethylsulfonic acid, propylsulfonic acid, butylsulfonic acid, or phenylsulfonic acid. The phosphonic acid may be selected from methylphosphonic acid, ethylphosphonic acid, propylphosphonic acid, butylphosphonic acid, dimethylphosphonic acid, diethylphosphonic acid, dipropylphosphonic acid, dibutylphosphonic acid, or diphenylphosphonic acid. Dialkylphosphonic acids may also be of mixed alkyl groups, for example, methylethylphosphonic acid. In a more specific embodiment, the stabilizing solution comprises formic acid, acetic acid, propionic acid, butanoic acid, and/or isobutanoic acid, in particular isobutanoic acid, n-butanoic acid and/or formic acid, most preferably isobutanoic acid. In an embodiment, a difference in a total internal energy (Δ U) between the acid of the organic moiety and a decarboxylated product of the acid of the organic moiety is about 15 U/kcal mol-1. The contacting period may be any suitable time, e.g., from 30 seconds to 12 hours, such as from 1 or 10 minutes up to 1 or 2 or more hours. In this embodiment, the amount of acid may range from about 0.5 to 20 mol equivalents of acid relative to MOF (assuming a MOF molecular weight of 1550 g/mol). Contacting the metal-organic framework with the acid containing stabilizing solution may take place under any suitable conditions, for instance by simple contacting at room temperature or under optional heating up to calcining temperature such as 250° C., most often at room temperature, optionally under mixing or stirring or mulling of the mixture (e.g., slurry). The contacting period may be any suitable time, e.g., from 30 seconds to 12 hours, such as from 1 or 10 minutes up to 1 or 2 or more hours.

Isolating the treated MOF from the treatment mixture can be conducted by standard means, such as via centrifugation or filtration. The treated MOF may be further washed by any standard means, for instance by water and/or a solvent such as methanol, ethanol, and/or acetone.

In an embodiment, at least a portion of the plurality of defects of the MOF have been capped or reinforced after treatment. In a further embodiment, the treated metal-organic framework obtained by the process of the first aspect of the present disclosure has at least part of its defects capped with an organic moiety selected from at least one of carboxylates, such as formate, acetate, benzoate, propionate, butanoate, and/or isobutanoate; sulfonates, such as methylsulfonate, ethylsulfonate, propylsulfonate, butylsulfonate, and/or phenylsulfonate; and phosphates, such as dimethylphosphate, diethylphosphate, dipropylphosphate, dibutylphosphate, or diphenylphosphate; and/or the metal-organic framework has at least part of its defects capped with an inorganic moiety selected from at least one of fluoride, sulfate, and bisulfate.

As described in Examples 1 to 11 herein, we also discovered that metal-organic framework materials treated with fluoride can load metallic species onto the framework to augment adsorption properties and impart catalytic efficacy.

Therefore, also provided herein, in a second aspect, are methods of making a metal-organic framework having improved CO₂ adsorption comprising contacting a metal-organic framework with metal cations and fluoride ions, for instance in the form of a metal fluoride, to produce a treated metal-organic framework comprising a non-framework cationic metal species and fluoride.

In an embodiment, the metal-organic framework has a cubic structure (where structure refers to Bravais lattice type).

In an embodiment, the metal-organic framework comprises a plurality of metals selected from aluminum, iron, zirconium, titanium and/or hafnium, in particular, the metal-organic framework is zirconium-based, titanium-based, and/or hafnium-based. In an embodiment, the metal-organic framework comprises Zr₆₋ₓM, metal nodes where M can be hafnium or titanium, or Zr₆ metal nodes. In a further embodiment, the metal-organic framework is a zirconium metal-organic framework or a zirconium-based metal-organic framework further comprising hafnium.

In an embodiment, the metal-organic framework is selected from EMM-71, UiO-66, UiO-67, UiO-68, MOF 808, zirconium fumarate, or NU 1000, in particular EMM-71.

In an embodiment, the source of fluoride ions is selected from ammonium fluoride and/or alkali metal fluorides, such as lithium fluoride, sodium fluoride, cesium fluoride, potassium fluoride, and mixtures thereof. In an embodiment, the metal cations (or cationic metal species) are selected from transition metals, such as from nickel, cobalt, copper, and/or silver. In an additional or alternative embodiment, the metal cations (or cationic metal species) are selected from alkali metals, such as from lithium, sodium, potassium and/or cesium, preferably potassium and/or cesium. Said source of metal cations (or cationic metal species) may be in any suitable form, such as in the form of metal chlorides, nitrates, and/or fluorides. In a particular embodiment, a metal fluoride may be used as the source of both fluoride ions and metal cations (or cationic metal species). Suitable examples of such metal fluorides include lithium fluoride, sodium fluoride, potassium fluoride, cesium fluoride, nickel fluoride, silver fluoride, cobalt fluoride, and/or copper fluoride, preferably potassium fluoride, cesium fluoride, nickel fluoride, silver fluoride, cobalt fluoride, and/or copper fluoride, optionally in the presence of ammonium fluoride. Without wishing to be bound by theory, it is believed that the fluoride ions induce negative charges on the MOF metal nodes (e.g., Zr-nodes) which allows for the retention of the metal cations in the treated MOF.

In an embodiment, the treated MOF is synthesized via contacting the metal-organic framework with a solution of metal cations and fluoride ions therefore producing a mixture, in particular a slurry, and optionally heating the mixture up to 50° C. or 60° C. Contacting may take place under any suitable conditions, optionally under mixing or stirring or mulling. The contacting period may be any suitable time, e.g., between 0 and 16 hours, for instance from 1 minute to 10 hours, such as for about 1 hour or 2 hours. Isolating the treated MOF from the treatment mixture can be conducted by standard means, such as via centrifugation or filtration. The treated MOF may be further washed by any standard means, for instance by water and/or a solvent such as methanol, ethanol, and/or acetone. However, excessive washing should be avoided to prevent washing away the fluoride and metal cations from the treated MOF.

In a further embodiment, the mol ratio of MOF metal (e.g., Zr) to metal cations in the mixture, when contacting takes place, may range from about 3:4 to 24:1, for instance from about 2:1 to 6:1. In a still further embodiment, the mol ratio of fluoride ions to metal cations in the mixture, when contacting takes place, may range from about 1:1 to 3:1, such as about 2:1. In all cases the molecular weight of the MOF is assumed to be 1550 g/mol (e.g., 258.3 g/mol Zr).

In an embodiment, the treated metal-organic framework obtained by the process of the second aspect of the present disclosure comprises the non-framework cationic metal species in an amount of at least about 0.1, such as at least about 0.15, for instance at least about 0.2, or even at least about 0.25 or 0.3, and up to about 0.65, such as up to about 0.5, for instance about 0.4 (i.e., atomic ratio of non-framework cationic metal species to MOF metal cations (e.g., Cu:Zr, Co:Zr, K:Zr, etc.) as measured by EDX or XRF). In an embodiment, the treated metal-organic framework obtained by the process of the second aspect of the present invention comprises fluoride ions in an amount of about 0.1 to 1, such as from about 0.2 to 0.8, for instance about 0.5 or 0.6 (i.e., atomic ratio of fluoride ions to MOF metal cations (e.g., F:Zr) as measured by EDX or XRF).

Also provided herein in a third aspect, is a modified EMM-71 metal-organic framework, in particular a metal-organic framework comprising EMM-71 and a moiety selected from the group consisting of formate, acetate, benzoate, propionate, butanoate, isobutanoate, methylsulfonate, ethylsulfonate, propylsulfonate, butylsulfonate, phenylsulfonate, dimethylphosphate, diethylphosphate, dipropylphosphate, dibutylphosphate, diphenylphophate, fluoride, sulfate, or bisulfate; for instance fluoride, isobutanoate, butanoate, and/or formate. Without wishing to be bound by theory, it is believed that at least a portion of the plurality of defects of the EMM-71 metal-organic framework are capped or reinforced by said moieties. This modified EMM-71 metal-organic framework may suitably be obtained by the method of the first aspect of the present disclosure.

Said modified EMM-71 metal-organic framework, in particular EMM-71 metal-organic framework comprising fluoride moieties, may further comprise non-framework cationic metal species, for instance selected from sodium, lithium, cesium, nickel, cobalt, copper, potassium, silver, and mixtures thereof, in particular lithium, cesium, nickel, cobalt, copper, potassium, and/or silver. Said cationic metal species may for instance be present in an amount of at least about 0.1, such as at least about 0.15, for instance at least about 0.2, or even at least about 0.25 or 0.3, and up to about 0.65, such as up to about 0.5, for instance about 0.4 (i.e., atomic ratio of non-framework cationic metal species to MOF metal cations (e.g., Cu:Zr, Co:Zr, K:Zr, etc.) as measured by EDX or XRF). This modified EMM-71 metal-organic framework may suitably be obtained by the method of the second aspect of the present disclosure.

Methods of Making Zirconium MOFs with Defects

In a traditional synthesis of producing zirconium MOFs, a linear bidentate (ditopic) ligand is dissolved in a polar aprotic solvent, typically dimethylformamide, with a source of zirconium (i.e., zirconyl chloride or zirconium tetrachloride) and a modulator. The modulator can be monocarboxylic acids such as formic, acetic, benzoic, or trifluoroacetic acid, but can also be water or hydrochloric acid. Polytopic organic carboxylic acids that can generate terephthalate linkers (i.e., terephthalic acid) have become universal in synthesizing zirconium-based metal-organic frameworks. Original synthetic protocols also included a step of heating the reaction mixture to yield polycrystalline powder.

Depending on the type of modulator used in the synthesis (acetic acid versus benzoic acid), surface area of the metal-organic framework can be adjusted. Moreover, concentration of the modulators has been shown to control linker vacancy. Further, the pKa of the carboxylic acid modulator is considered to be equally influential variable. Likewise, water can effectively generate defects when very low water content is used to synthesis node-defected UiO-66 as well as methyl and amino-functionalized analogues.

To create missing node defects, we have recently developed a new synthesis to produce metal-organic frameworks having missing-cluster/node defects more effectively than previously known. See, U.S. Patent Application No. 63/202,856, Metal Organic Frameworks Having Node Defects and Methods of Making the Same, filed Jun. 28, 2021. As described, we have shown that inclusion of select divalent metals, not only induce the node defect, but select divalent metals can induce the generation of missing clusters at a much higher degree than prior art methodologies. Similar levels of defects have also been demonstrated using concentratred reaction conditions with a pre-ligand. See, U.S. Patent Application No. 63/296,178, Method of Making Metal-Organic Frameworks with a Ligand Precursor and Crystallization Aide, filed Jan. 4, 2022. As described, we have shown that this synthesis method can produce EMM-71 (and functionalized derivatives) without the use of divalent metals or amide solvents.

Beyond the unexpected role of select divalent metal cations on missing-node defect formation, we observed that the efficacy of the cation is dependent on the presence of halide cations in solution and that the process was reversible through the addition of either HCl or NH₄Cl. For example, while NH₄Br can be effective, oxidation of the bromide anion to elemental bromine can interfere in this process. Conversely, fluoride causes the formation of alternative phases and, therefore, the metal organic framework will not form with the addition of ammonium fluoride in the synthesis of the metal-organic framework.

In addition, only modest amounts of chloride can actuate a REO-generating mechanism, or the transition from FCU topology to REO topology. Non-halide metal modulators such as zinc oxide (as well as zinc metals as divalent zinc sources) effectively generates a transition from FCU topology to REO topology and the REO domains. In the case of zinc oxide, it appears that oxide reacts with acetic acid in the reaction to form zinc acetate and water. However, zinc metal will generate flammable gas and zinc oxide can affect the acid/base properties of the solution.

Defect-generating cations, measured as M:Zr, appear to be optimal at approximately 37 wt. %. Lower, ratios of approximately 25 wt % divalent cation are effective in generating REO defects (referred to as missing-clusters or node defects in a reo topology), especially when measured by powder X-ray diffraction (“PXRD”). Further it appears that porosity is easier to maximize at the slightly higher value. When divalent cation content dropped to about 10 wt. % relative to zirconium, attenuated peaks can be observed. Excess acetate and high pH can affect the solution processes and provide missing-node defects.

In addition to the halide concentration, other variables can influence the degree of defects of the resulting metal-organic framework materials including (1) acetic acid concentration, (2) water content, (3) reaction temperature, (4) metal/ligand ratio, and (5) divalent dopant content. While water forms zirconium secondary building units, a tension forms as overly high concentration can result in a decrease in defect density, requiring an upper bound for reaction concentration. When using hydrated salts, beyond a certain reaction concentration, high yield and high defect concentrations are not produced regardless of water concentration. This can be ameliorated through the use of anhydrous salts such as ZrCl₄, or by slowly adding zirconium to the reaction medium. For characterizing nanoscale materials, powder X-ray diffraction is described in an editorial published by the American Chemical Society, Holder, C. F. et al. (2019) “Tutorial on Powder X-ray Diffraction for Characterizing Nanoscale Materials,” ACS Nano, v.13(7), pp. 7359-7365.

In addition to acetic acid and water, we also observed that temperature was an important variable in the synthesis of node-defected metal-organic framework. Like Lillerud's observation, high temperature reaction conditions tend to produce low defect-containing materials. See, Shearer, et al. (2016) “Functionalizing the Defects: Postsynthetic Ligand Exchange in the Metal-Organic Framework UiO-66,” Chem. Mater., v.28(20), pp. 7190-7193. In that particular work, reaction conditions were screened between 100° C. and 220° C., with materials synthesized at 220° C. having nearly no defects. In the case of metal-organic frameworks having REO topology, temperature dependence is accentuated. Reactions conducted between 80° C. and 130° C. were conducted and it was observed that high levels of defects only dominated the PXRD pattern when reactions were conducted between 90° C. and 100° C. Below this temperature, large amounts of unreacted BDC were present and above these temperatures, attenuated reflections of the REO domains occurred.

To remove pendant ligands and realize pore volumes indicative of a structure having defects, defective MOF can be washed in slightly basic solutions. For example, sodium borate, a weakly interacting anion (as opposed to phosphate or carbonate) and buffers at the modest pH of 9 can be used to wash the MOF and significant decrease in peak intensity may be observed.

Formate washed material can provide an increase in the measured micropore volume and surface area. These results, however represent a non-optimized washing procedure. The removal of pendant ligands is concomitant with structural degradation resulting from the high temperature, high pH conditions of the synthesis.

As detailed in U.S. Provisional Application No. 63/202,856, filed on Jun. 28, 2021, the general steps required to make a metal-organic framework characterized by a high number of missing-cluster/node defects (e.g., EMM-71) comprise: (a) reacting a first metal source that can generate a tetravalent metal cation in solution (e.g., in the form of a metal precursor, a metal complex or a metal oxide), a polytopic organic carboxylic acid that can generate terephthalate linkers, a second metal source that can generate a divalent cation in solution (e.g., in the form of a metal precursor, a metal complex or a metal oxide), and one or more monocarboxylic acids in a solvent to provide a reaction solution; (b) heating the reaction solution, e.g., to a reaction temperature of at least 75° C., to provide a reaction mixture; and (c) separating the metal-organic framework material from the reaction mixture. The reaction mixture comprises a metal-organic framework material and the metal-organic framework material comprises a plurality of metal-organic frameworks. Following this method, each of the plurality of metal-organic frameworks having a plurality of tetravalent cations and terephthalate linkers are crystallized in a primitive cubic lattice (i.e., cubic Bravais lattice type).

In an embodiment, methods to synthesize a metal-organic framework with defects include a monocarboxylic acid, for instance, selected from formic, acetic, benzoic, difluoroacetic or trifluoroacetic acid. In an embodiment, the monocarboxylic acid concentration is between about 30 volume % and 70 volume % of the total volume of solvent (the total volume of solvent being calculated as the total amount of monocarboxylic acid(s), organic solvent(s) and optional water present in the reaction solution). Furthermore, in an embodiment, the methodology to make MOFs with defects include a tetravalent cation to linker (in particular to terephthalate linker) mol ratio of between about 1.75:1 and about 1:1.75. Also, in an embodiment, the divalent cation to the tetravalent cation mol ratio is about 0 to about 5. In an embodiment, the reaction solution can further comprise water in a concentration between about 0 moles and 5 moles per liter of the total reaction volume. In an embodiment, the first metal is selected from zirconium, hafnium, titanium, cerium, or a mixture thereof e.g., Zr or a combination of Zr and Hf. In an embodiment, the second metal is chosen from Zn, Co, Sn, Cu, or a mixture thereof. In an embodiment, the polytopic organic carboxylic acid is selected from an aromatic di, tri or tetracarboxylic acid that can generate terephthalate linkers. In an embodiment, the polytopic organic carboxylic acid is selected from terephthalic acid or trimesic acid. In an embodiment, the polytopic organic carboxylic acid is functionalized, e.g., by an alkyl, halo, nitro, cyano, amino, sulfonyl, thio, isocyano, alcoxy, ether, ester, or carboxylate group. In an embodiment, the solvent is a polar aprotic solvent, for instance dimethylformamide (DMF).

In an embodiment, the reaction solution further comprises one or more of F, Cl, Br or I ions, in particular Cl.

### Post-Synthesis Treatments of Zirconium Metal-Organic Frameworks

As described above, UiO-66 was first discovered in 2008 and represented a multifaceted change in the development of chemically and thermally stable metal-organic frameworks. At the time of the discovery, the original material (comprising terephthalate linkers and zirconium cations) lacked chemical functionalization. Unlike many other MOFs, in its original form, the metal-organic framework UiO-66 did not have open metal sites intrinsic to the crystal structure and its organic ligand did not contain sites for addition of functionalization. As also described above, synthesis have been developed to generate defects in UiO-66 and other zirconium MOFs that provide sites for chemistry and adsorption (open metal sites).

In addition, post-synthetic modifications (exchange of either metal cations or ligands post synthesis) have been successful to impart chemical function into UiO-66 but are challenging to utilize at higher scale. Further, utilizing these techniques to anchor cationic species, relevant to separations and catalysis, is labor intensive, requiring multiple transformations of a base material.

For example, reactions of unfunctionalized MOF materials with highly reactive species including metal alkyl species such as trimethylaluminum, alkyl lithium, alkyl Grignard reagent to create sites that could be subsequently metal exchanged have been developed. See e.g., Drake, T. et al. (2018) “Site Isolation in Metal-Organic Frameworks Enables Novel Transition Metal Catalysis,” Acc. Chem. Res., v.51, pp. 2129-2138; Ji, P. et al. (2016) “Single-Site Cobalt Catalysts at New Zr₈(μ₂-O)₈(μ₂-OH)₄ Metal-Organic Framework Nodes for Highly Active Hydrogenation of Alkenes, Imines, Carbonyls, and Heterocycles,” J. Am. Chem. Soc., v.138, pp. 12234-12242; Zhang, T. et al. (2016) “Metal-Organic Frameworks Stabilize Solution-Inaccessible Cobalt Catalysts for Highly Efficient Broad-Scope Organic Transformations,” J. Am. Chem. Soc., v.138, pp. 3241-3249; Manna, K. et al. (2016) “Chemoselective single-site Earth-abundant metal catalysts at metal-organic framework nodes,” Nat. Commun., v.7, pg. 12610; Manna, K. et al. (2016) “Metal-Organic Framework Nodes Support Single-Site Magnesium-Alkyl Catalysts for Hydroboration and Hydroarnination Reactions,” J. Am. Chem. Soc., v.138, pp. 7488-7491; Li, Z. et al. (2016) “Sintering-Resistant Single-Site Nickel Catalyst Supported by Metal Organic Framework,” J. Am. Chem. Soc., v.138(6), pp. 1977-1982; Ahn, S. et al. (2016) “Stable Metal-Organic Framework-Supported Niobium Catalysts,” Inorg. Chem., v.55, pp. 11954-11961; Liu, J. et al. (2018) “Beyond the Active Site: Tuning the Activity and Selectivity of a Metal-Organic Framework-Supported Ni Catalyst for Ethylene Dimerization,” J. Am. Chem. Soc., v.140(36), pp. 11174-11178; Mondloch, J. E. et al. (2013) “Vapor-Phase Metalation by Atomic Layer Deposition in a Metal-Organic Framework,” J. Am. Chem. Soc., v.135(28), pp. 10294-10297; Zhang, T. et al. (2016) “Metal-Organic Frameworks Stabilize Solution-Inaccessible Cobalt Catalysts for Highly Efficient Broad-Scope Organic Transformations,” J. Am. Chem. Soc., v.138, pp. 3241-3249; Kung, C-W. et al. (2015) “Metal-Organic Framework Thin Films as Platforms for Atomic Layer Deposition of Cobalt Ions To Enable Electrocatalytic Water Oxidation,” ACS Appl. Mater. Interfaces, v.7(51), pp. 28223-28230; Ahn, S. et al. (2018) “Pushing the Limits on Metal-Organic Frameworks as a Catalyst Support: NU-1000 Supported Tungsten Catalysts for o-Xylene Isomerization and Disproportionation,” J. Am. Chem. Soc., v.140(27), pp. 8535-8543; Platero-Prats, A. et al. (2017) “Bridging Zirconia Nodes within a Metal-Organic Framework via Catalytic Ni-Hydroxo Clusters to Form Heterobimetallic Nanowires,” J. Am. Chem. Soc., v.139(30), pp. 10410-10418; and Peters, A. W. et al. (2015) “Atomically Precise Growth of Catalytically Active Cobalt Sulfide on Flat Surfaces and within a Metal-Organic Framework via Atomic Layer Deposition,” ACS Nano, v.9(8), pp. 8484-8490. Alternatively, metals can incorporate into zirconium secondary building units in dimethylformamide. Yuan. S. et al. (2015) “Cooperative Cluster Metalation and Ligand Migration in Zirconium Metal-Organic Frameworks,” Angew Chemie Int. Ed., v.54(49), pp 14696-14700. However, this effect was not demonstrated in water which would be expected to hinder the metal incorporation step. See e.g., Abdel-Mageed, A. M., et al. (2019) “Highly Active and Stable Single-Atom Cu Catalysts Supported by a Metal-Organic Framework,” J. Am. Chem. Soc., v.141(13), pp. 5201-5210.

The incorporation of fluoride into zirconium MOFs has been undertaken. Lin, K-Y A. et al. (2016) “Adsorption of fluoride to UiO-66-NH₂ in Water: Stability, Kinetic, Isotherm and Thermodynamic Studies,” J. Col. Inter Sci., v.461, pp. 79-87; Zhao, X. et al. (2014) “The Stability and Defluoridation Performance of MOFs in Fluoride Solutions,” Micro. Meso. Mater., v.185, pp. 72-78; Prabhu, S. M. et al. (2021) “Synthesis and Characterization of Defective UiO-66 for Efficient Co-immobilization of Arsenate and Fluoride from Single/Binary Solutions,” Environ. Poll., v.278, pg. 116841. However, to date, the ability of these fluoride materials to adsorb cations had not been explored. We have discovered that materials treated with fluoride can load metallic species onto the framework to augment adsorption properties and impart catalytic efficacy.

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results. The following non-limiting examples are provided to illustrate the disclosure.

### EXAMPLES

The samples were analyzed on either a Panalytical XPert Pro powder X-ray diffractometer fitted with an Anton Paar HTK-16N environmental stage equipped with a Pt-strip heater, or a Bruker D8 Envdevor instrument in continuous mode using a Cu Kα radiation, Bragg-Bentano geometry with Lynxeye detector, in the 20 range of 2 to 60°. In both cases, the interplanar spacings, d-spacings, were calculated in Angstrom units. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak fitting algorithm using a 3rd order polynomial background fit. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history. All samples were analyzed as is and without any further grinding. All X-ray diffraction patterns collected at elevated temperatures were collected during a temperature programmed ramp described in Example 18 and FIG. 16. Each scan was ˜20 minutes in length ranging from 2-60° 2θ with 0.02° step sizes. The portions of the temperature program that correspond to measurements are represented in FIG. 16 as dashed lines.

Atomic ratios were collected by Energy Dispersive X-Ray (EDX), using a Thermo Fisher Apreo 2 S HiVac with dual Oxford Ultim Max170 EDS detectors. Processed with Oxford Aztec software. Samples were analyzed at 5 or 15 keV at 0.2-0.8 nA of current; or by X-ray fluorescence (XRF), using a Burker S8 Tiger X-ray Fluorescence instrument using a Rh X-ray tube operating at 3 kW (60 kV, 150 mA) in an wavelength disperse XRF mode.

Gravimetric CO₂ uptake (adsorption and capacities) were measured at 1 bar of 85/15 CO₂/N₂ using a Mettler Toledo TGA/DSC1 thermogravimetric analyzer. Before measurement, the samples were outgassed in the analyzer at 140° C. under a stream of N₂. The samples were then allowed to cool to 35° C. and the gas switched to an 85/15 mix of CO₂/N₂ at 1 bar.

As set out in Example 1 through Example 11 below, we leveraged the adsorption of a fluoride species into zirconium metal organic frameworks to enable the adsorption of metal species relevant for adsorption and catalytic applications, in support of the method of the first aspect of the present disclosure.

Example 12 through Example 19 below illustrate thermal stabilization of zirconium metal organic frameworks, in support of the method of the second aspect of the present disclosure.

### Example 1: Synthesis of EMM-71-Formate

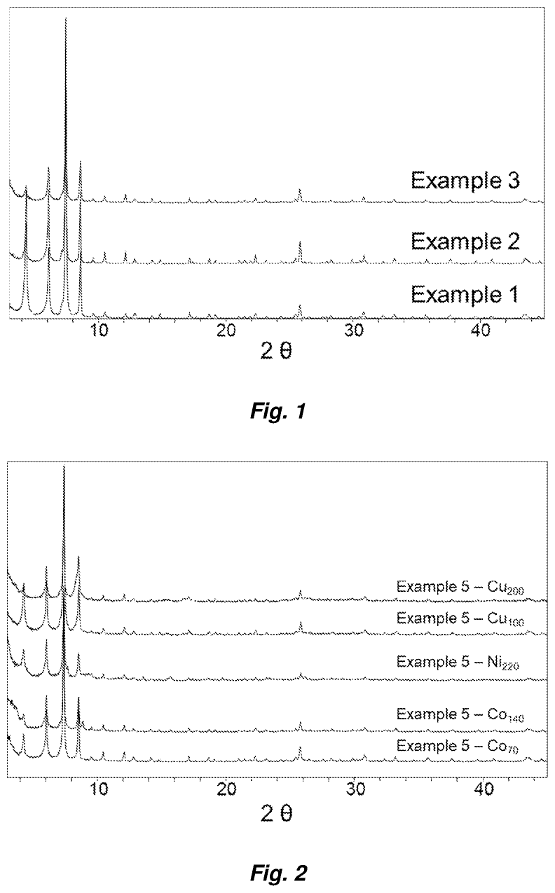

The metal-organic framework EMM-71 was synthesized through methods taught in 63/202,856 or in 63/296,178. EMM-71 was then suspended in 0.25 M sodium formate to make a 10 wt. % MOF suspension (e.g., 10 grams (“g”) of formate solution per gram of EMM-71). The solution was heated to 100° C. for 30 minutes and then filtered and the filter cake was washed with a 1 vol % formic acid solution (equal volume to that of initial sodium formate solution). The filter cake was then rinsed with acetone to displace the water and the cake allowed to air dry. This dry powder corresponds to EMM-71 wherein the defects are capped with formate and is referred to as EMM-71-Formate. FIG. 1 provides the powder X-ray diffraction patterns of materials prepared in Examples 1, 2 and 3.

### Example 2: Synthesis of EMM-71-HCl

EMM-71-Formate from Example 1 was weighed out and added to a beaker. 1 vol % HCl solution was added to the beaker to create a 10 wt. % slurry. The slurry was stirred at room temperature for 30-90 minutes then filtered. The filter cake was then washed with at least 3 volume equivalents (with respect to the volume of the initial MOF/HCl slurry) of water. The filter cake was then washed with acetone to displace the water and allowed to dry. Washing with HCl results in exposing all the defects. The resulting powder is EMM-71-HCl (see PXRD pattern in FIG. 1).

### Example 3: Synthesis of EMM-71-Fluoride (EMM-71-F)

EMM-71-Formate from Example 1 or EMM-71-HCl from Example 2 was massed out into a vessel and suspended in water to create a 10 wt. % slurry. To this, sodium fluoride was added (10 wt. % with respect to the MOF). The mixture was stirred and heated (35° C. to 50° C.) for 90 minutes. The mixture was then filtered and washed with 3 volume equivalents of water with respect to the initial slurry volume. The resulting powder is EMM-71-F (see PXRD pattern in FIG. 1).

### Example 4: Treatment of EMM-71-HCl with Copper Chloride Dihydrate or Cobalt Chloride (Anhydrous)

500 mg of EMM-71-HCl from Example 2 was suspended in 10 mL of water. Either 250 mg of copper chloride dehydrate or 187 mg of cobalt chloride (anhydrous) was added to the mixture and stirred at 50° C. The mixture was then filtered, washed with 2 volume equivalents of water and then acetone. The filter cake was allowed to dry.

### Example 5: Treatment of EMM-71-HCl with Copper Fluoride Hydrate, Cobalt Fluoride, or Nickel Fluoride in the Presence of Ammonium Fluoride

500 mg of EMM-71-HCl from Example 2 was suspended in 5 mL of deionized water and either 100 or 200 mg of copper fluoride dihydrate, 70 or 140 mg of cobalt fluoride, or 220 mg of nickel fluoride was added along with 100 mg of ammonium fluoride. The mixture was stirred at 50° C. for 90 minutes then filtered and washed with water followed by acetone. FIG. 2 shows the powder X-ray diffraction patterns of the materials prepared in Example 5.

### Example 6: Treatment of EMM-71-HCl with Copper Chloride Dihydrate or Cobalt Chloride (Anhydrous) and Ammonium Fluoride

1,000 mg of EMM-71-HCl from Example 2 was suspended in 10 mL of deionized water and 250 mg of copper chloride dihydrate was added along with 100-150 mg of ammonium fluoride. The mixture was then heated to 50° C. for 90 minutes then filtered and washed with water followed by acetone.

2 g of EMM-71-HCl from Example 2 was suspended in 20 mL of deionized water and 330 mg of cobalt chloride were added along with 420 mg of ammonium fluoride. The mixture was then heated to 50° C. for 90 minutes then filtered and washed with water followed by acetone.

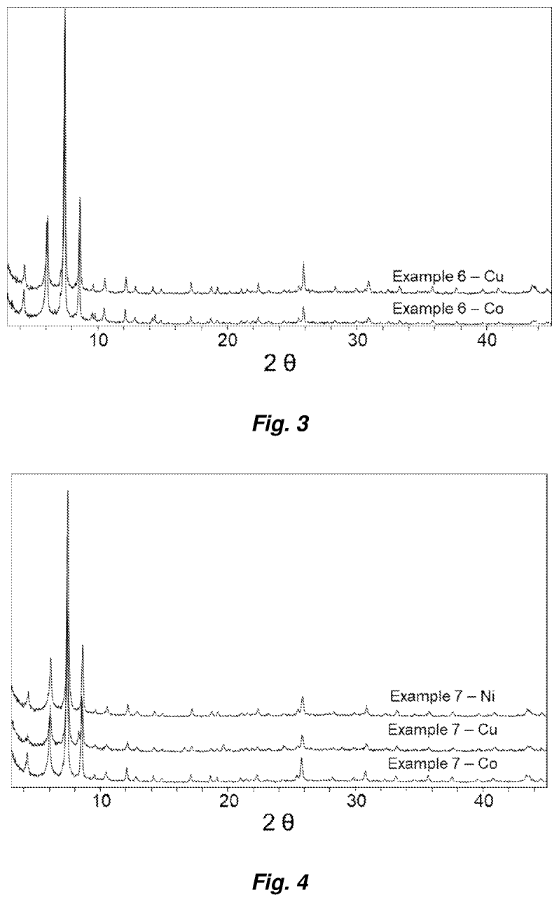

FIG. 3 shows the powder X-ray diffraction patterns of the materials prepared in Example 6.

### Example 7: Treatment of EMM-71-F with Metal Chlorides in the Presence of Ammonium Fluoride

500 mg of EMM-71-F from Example 3 was suspended in 5 mL of water with 50 mg of ammonium fluoride. Either 82 mg of cobalt chloride (anhydrous), 109 mg of copper chloride dihydrate, or 305 mg of nickel chloride hexahydrate were added. The reaction mixtures were stirred for 90 minutes at 50° C. and then subsequently filtered, washed with water and then acetone and allowed to air dry. FIG. 4 shows the powder X-ray diffraction patterns of the materials prepared in Example 7.

### Example 8: Treatment of EMM-71-F with Metal Salts without Fluoride Present

500 mg of EMM-71-F from Example 3 was suspended in 5 mL of water. Either 82 mg of cobalt chloride (anhydrous), 109 mg of copper chloride dihydrate, 305 mg of nickel chloride hexahydrate, or 135 mg of silver nitrate was added. The reaction mixtures were stirred for 90 minutes at 50° C. and then subsequently filtered, washed with water and then acetone and allowed to air dry. In the case of silver samples, the reactions were shielded from light. These results show that, even if the MOF is pre-fluorinated, in the absence of additional fluoride during treatment with the metal salts, only a limited amount of metal is adsorbed besides silver (see Table 1).

### Example 9: Treatment of EMM-71-HCl with Alkali Metal Fluoride Salts

6 g of EMM-71-HCl from Example 2 was suspended in 40 mL of water and either 1.12 grams of potassium fluoride or 1.47 grams of cesium fluoride was added to the mixture. The mixture was heated to 50° C. and stirred for 90 minutes. The solids were filtered out and washed with 10 mL of deionized water. The water was then exchanged with acetone and the filter cake allowed to dry. FIG. 5 shows the powder X-ray diffraction pattern of the materials prepared in Example 9.

### Example 10: Treatment of EMM-71-Formate with Alkali Metal Fluoride Salts

500 mg of EMM-71-Formate from Example 1 was suspended in 5 mL of water and between 50 and 200 mg of cesium fluoride was added to the reaction mixture and it was heated to 50° C. for 90 minutes. The solids were filtered out and washed with 10 mL of deionized water. The water was then exchanged with acetone and the filter cake allowed to dry. FIG. 5 further shows the powder X-ray diffraction patterns of the materials prepared in Example 10.

### Example 11: Gravimetric CO₂ Uptake Measurements

Samples of Examples 1, 2, 9 and 10 herein were outgassed in a thermogravimetric analyzer at 140° C. under a stream of N₂. The samples were then allowed to cool to 35° C. and the gas switched to an 85/15 mix of CO₂/N₂ at 1 bar.

Table 1 below sets out the atomic ratios collected by EDX (for Example 1, 2, 3, 4, 5, 6 and 7 ratios) and by XRF (for Example 8 and 9 ratios).

TABLE 1
Atomic Ratios Collected by EDX or XRF
(Examples 8-9 values are from EDX)

| Sample | Zr | M | Cl |
|---|---|---|---|
| Example 1 | 1 | n/a | 0.013 |
| Example 2 | 1 | n/a | 0.335 |
| Example 3 | 1 | n/a | BDL* |
| Example 4 - Cu | 1 | BDL | 0.226 |
| Example 4 - Co | 1 | BDL | 0.178 |
| Example 5 - Cu₂₀₀ | 1 | 0.49 | 0.001 |
| Example 5 - Co₁₄₀ | 1 | 0.35 | 0.001 |
| Example 6 - Co | 1 | 0.1 | BDL |
| Example 6 - Cu | 1 | 0.15 | 0.01 |
| Example 7 - Co | 1 | 0.11 | BDL |
| Example 7 - Cu | 1 | 0.18 | BDL |
| Example 7 - Ni | 1 | 0.05 | BDL |
| Example 8 - Co | 1 | BDL | BDL |
| Example 8 - Cu | 1 | 0.02 | BDL |
| Example 8 - Ni | 1 | BDL | BDL |
| Example 8 - Ag | 1 | 0.18 | BDL |
| Example 9 - K | 1 | 0.348 | BDL |
| Example 9 - Cs | 1 | 0.26 | BDL |

*BDL = below detectable level

Table 2 immediately below provides the gravimetric CO₂ adsorption capacities measured at 1 bar of 85/15 CO₂/N₂.

TABLE 2
Gravimetric CO₂ adsorption capacities
measured at 1 bar of 85/15 CO₂/N₂

| | Desorption/ | | |
|---|---|---|---|
| | Adsorption | CO₂ Ads | CO₂ capacity |
| Sample | Temperature | (wt %) | (mmol/g) |
| Example 1 - EMM-71-formate | 140/35° C. | 2.57 | 0.83 |
| Example 2 - EMM-71-HCl | 140/35° C. | 2.17 | 0.76 |
| Example 9 - K | 140/35° C. | 3.60 | 1.02 |
| Example 9 - Cs | 140/35° C. | 3.98 | 1.10 |
| Example 10 (50 mg CsF) | 140/35° C. | 3.01 | 1.01 |
| Example 10 (100 mg CsF) | 140/35° C. | 2.51 | 0.84 |
| Example 10 (150 mg CsF) | 140/35° C. | 2.57 | 0.83 |
| Example 10 (200 mg CsF) | 140/35° C. | 2.56 | 0.85 |

### Example 12: UiO-66 Thermal Stabilization Through Ammonium Fluoride Treatment

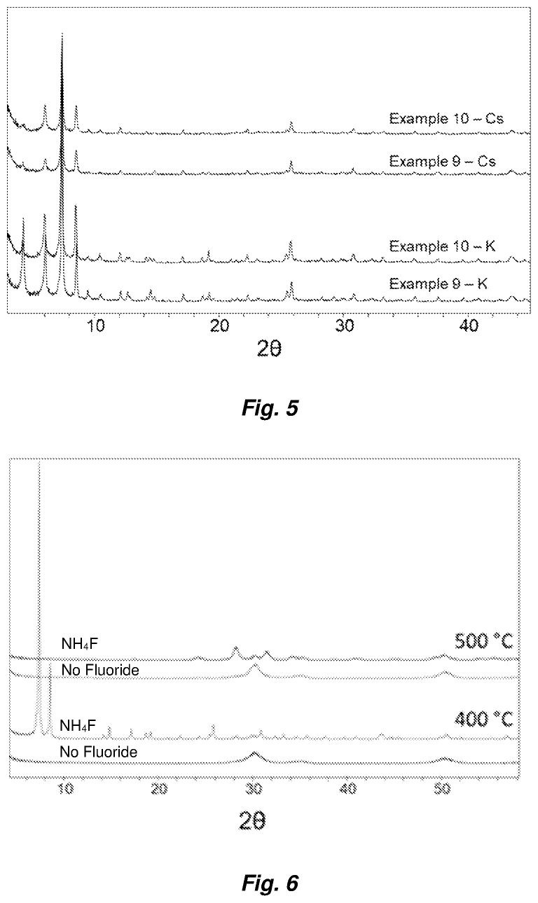

300 mg samples of UiO-66 were massed out and suspended in 1 mL aqueous solution containing 30 mg of ammonium fluoride and briefly mixed to homogenize. The samples were then calcined at temperatures between 350 and 500° C. and compared with untreated UiO-66 samples. Samples that were calcined in the presence of F-showed higher degrees of thermal stability, maintaining the PXRD pattern at temperatures of 450° C. This compares to untreated materials which exhibit a complete loss of crystallinity at temperatures of 400° C. FIG. 6 shows the powder X-ray diffraction patterns of UiO-66 samples calcined after treatment with and without NH₄F at 400 and 500° C.

### Example 13: Defect Removal and Thermal Stabilization in EMM-71 Through Ammonium Fluoride Treatment

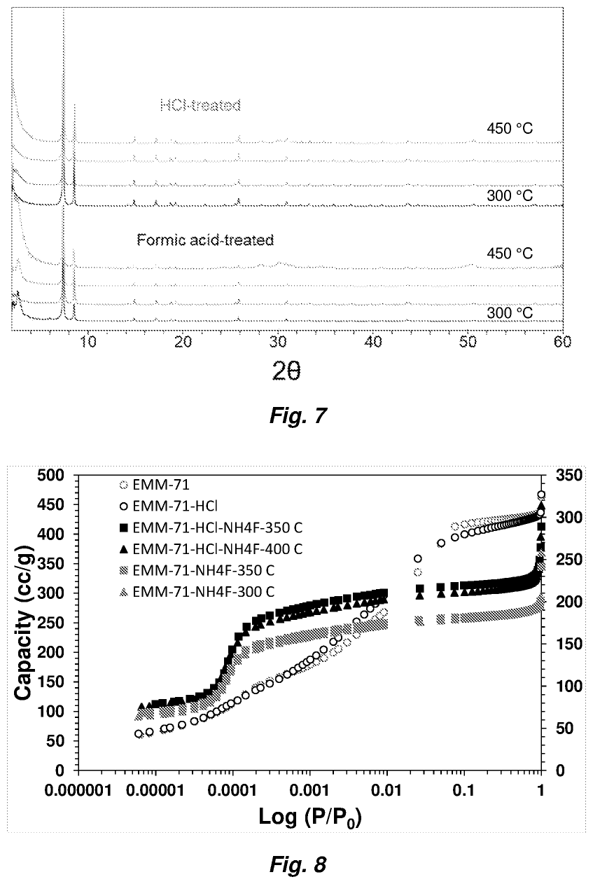

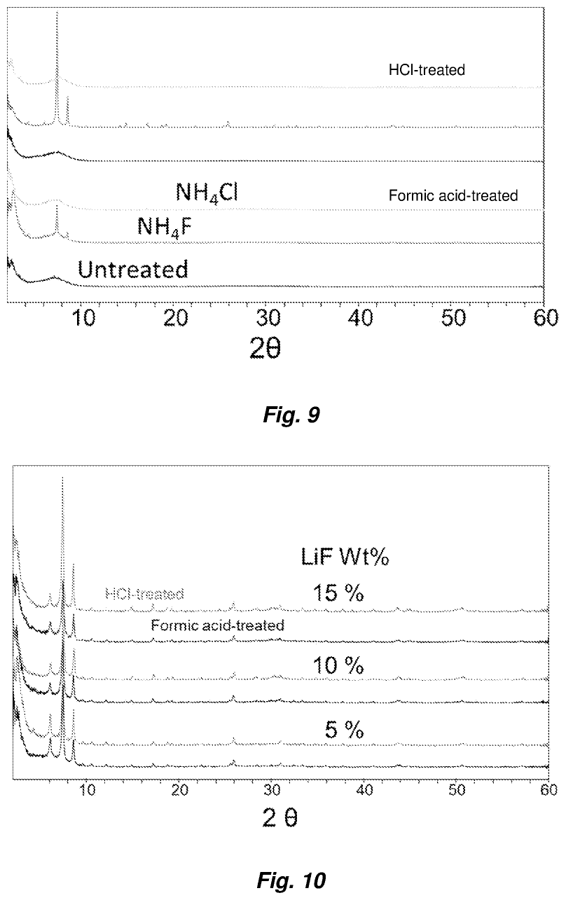

300 mg samples of EMM-71 (EMM-71-Formate of Example 1 or EMM-71-HCl of Example 2) were massed out and suspended in 1 mL aqueous solution containing 30 mg of ammonium fluoride and mixed briefly to homogenize. The samples were then calcined at temperatures between 300 and 500° C. Samples that were calcined in the presence of F show higher degrees of thermal stability while maintaining the PXRD pattern at temperatures of 450° C. This compares to untreated materials which exhibit a complete loss of crystallinity at temperatures of 300° C. FIG. 7 shows the powder X-ray diffraction patterns of EMM-71 samples treated with either formic acid (i.e., EMM-71-Formate of Example 1) or hydrochloric acid (i.e., EMM-71-HCl of Example 2), and calcined in the presence of ammonium fluoride from temperature of 300° C. to 450° C. in 50° C. increments. FIG. 8 shows the nitrogen adsorption isotherms of the EMM-71 samples treated with ammonium fluoride sources and calcined. FIG. 9 shows the powder X-ray diffraction patterns of EMM-71-Formate and EMM-71-HCl samples (from respectively Examples 1 and 2) treated with ammonium fluoride or ammonium chloride and heat treated at 300° C. for four (4) hours.

### Example 14: Thermal Stabilization of EMM-71 with Limited Defect Removal Through Lithium Fluoride Treatment

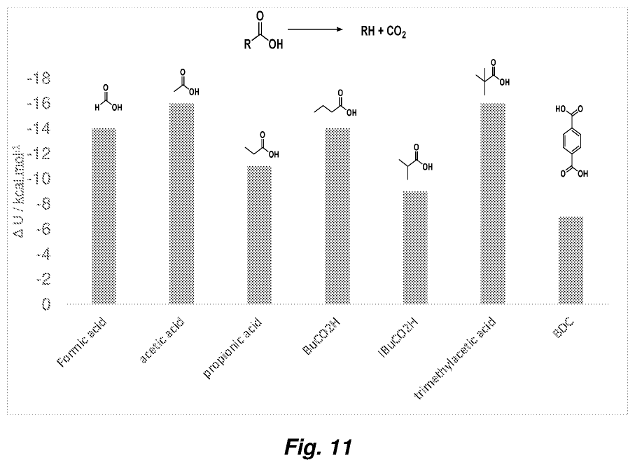

300 mg samples of EMM-71 (EMM-71-Formate of Example 1 or EMM-71-HCl of Example 2) were massed out and suspended in 2 mL of water with 15, 30 or 45 mg of lithium fluoride. The samples were stirred at 80° C. for 1 hour and then calcined under air at 350 for 12 hours after a four hour (4 hr) ramp. The samples exhibit powder X-ray diffraction patterns that still contain the distinct peaks at 4 and 6° 20, indicative of defects remaining. FIG. 10 shows the powder X-ray diffraction patterns of EMM-71 samples, both formic acid and hydrochloric acid-treated (i.e., respectively EMM-71-Formate of Example 1 and EMM-71-HCl of Example 2), calcined in the presence of different weight percent lithium fluoride.

### Example 15: Thermal Stabilization of EMM-71 with Limited Defect Removal Through Isobutyric Acid Treatment

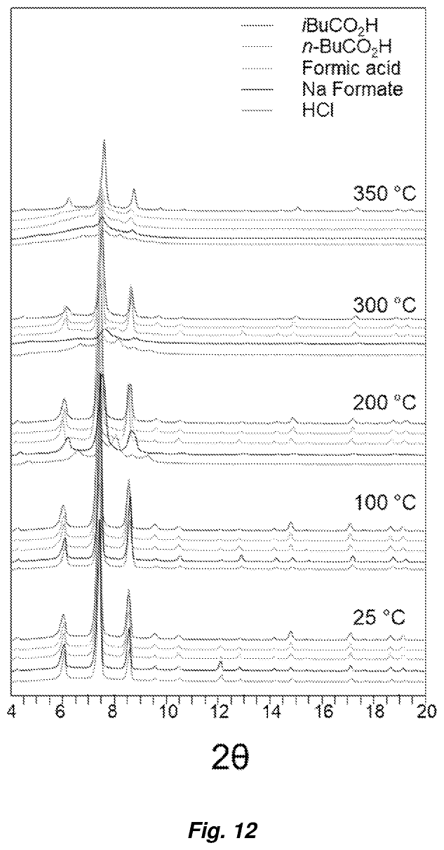

Defects capped with organic moieties can also be robust to thermal degradation. The limit of thermal stability is tied to the intrinsic thermal stability of the organic moiety. Through density functional theory (DFT) modeling, we predicted that isobutanoic acid would exhibit superior thermal protection when compared to other organic acids. Isobutanoic acid can be added in several ways. Samples of EMM-71 can be suspended, optionally with stirring, in aqueous solutions of the acid (˜0.25 M), with optional heating, and then isolated via filtration. Alternatively, EMM-71 can be mulled with a solution of isobutanoic acid (234 uL/g of MOF with enough water to create a slurry) and calcined, resulting in thermally stable materials. FIG. 11 shows density functional theory (“DFT”) calculations depicting the difference in total internal energy of various acids and decarboxylated products. FIG. 12 shows powder X-ray diffraction patterns of EMM-71 samples after washing with various mixtures (i.e., isobutyric acid (or isobutanoic acid), n-butanoic acid, formic acid, sodium formate, and HCl); said patterns being collected at temperatures between 25° C. and 350° C. These results illustrate the following stabilizing efficiency: isobutyric acid (i-BuCO₂H))>n-butanoic acid (n-BuCO₂H)˜ formic acid>sodium formate>HCl.

### Example 16: Thermal Stabilization of Commercial Samples of Zr-Fumarate Through Ammonium Fluoride Treatment

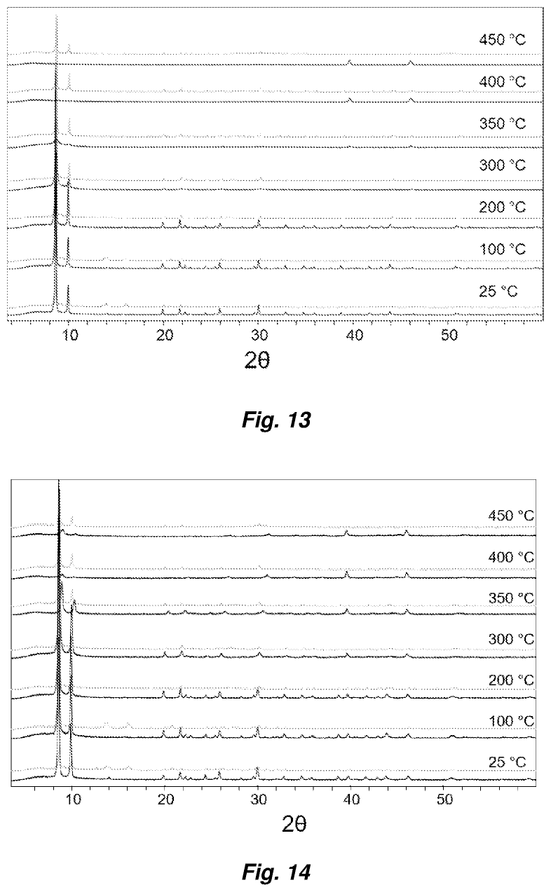

In this example, NH₄F treatment of Zirconium fumarate (fumarate analogue of UiO-66) is illustrated. Samples of zirconium fumarate were purchased from Strem Chemical, with Zr:Fumaric acid mol ratio of respectively 0.68-0.92 (Strem Item #40-1114) and 0.91 (Strem Item #40-1106). Zr-fumarate was mixed with ammonium fluoride to make a 10 wt. % mixture of NH₄F relative to MOF. Minimal water was added and the mixture agitated and allowed to dry at 100° C. The powder X-ray diffraction patterns of Zr-Fumarate (a fumarate analogue of UiO-66) having a fumaric acid to zirconium mol ratio of 0.68-0.92 before and after NH₄F treatment; said patterns were collected at temperatures between 25° C. and 450° C. are shown in FIG. 13. The powder X-ray diffraction patterns of Zr-Fumarate having a fumaric acid to zirconium mol ratio of 0.91 before and after NH₄F treatment; said patterns were collected at temperatures between 25° C. and 450° C. are shown in FIG. 14.

### Example 17: Calculation of Δ U Using Dmol3

Molecular models were generated for the starting carboxylic acid, the resulting carbon dioxide (or carbon monoxide in the case of formic acid) and the resulting alkane (or water in the case of formic acid). The ‘geometry optimization’ module of DMol3 using the following parameters: quality fine; functional “hybrid”+“B3LYP”; spin unrestricted=yes; Use Formal Spin as Initial=yes; Charge=0. For the calculation of the alkane and CO₂, both molecules were in the same model and spaced apart to avoid interactions being included in the calculations.

### Example 18: Thermal Stabilization with Sulfuric Acid Treatment of MOFs

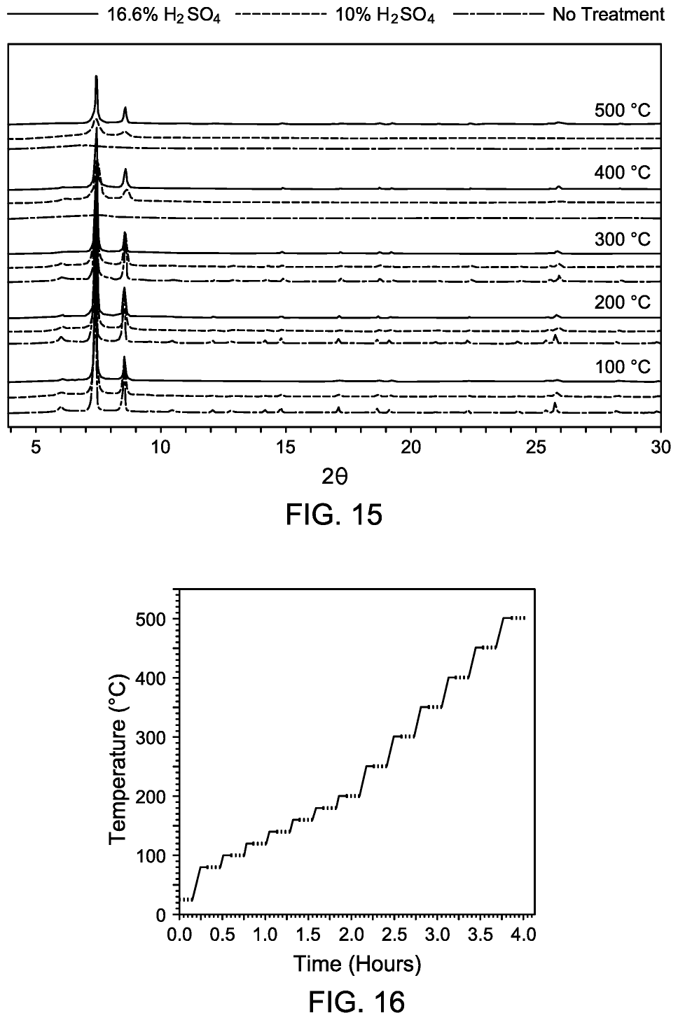

5 grams of EMM-71 was weighed out and 50 mL of water added to create a slurry. 500 mg or 1,000 mg of concentrated sulfuric acid (resulting in 10 or 20 wt % H₂SO₄ solutions) was added and the mixture stirred at room temperature for 2 hours. The mixture was then filtered and washed with methanol (or alternatively ethanol, acetone, and/or water). The isolated solids were dried at 100° C. to 150° C. FIG. 15 shows powder X-ray diffraction patterns collected on a sample of EMM-71 before (black) and after (gray) the treatment. The temperatures correspond to the temperature programed PXRD experiment detailed in Example 19.

### Example 19: Temperature Programmed Powder Xray Diffraction

Samples were analyzed on a Panalytical XPert Pro powder X-ray diffractometer fitted with an Anton Paar HTK-16N environmental stage equipped with a Pt-strip heater. The samples were treated in accordance to the temperature program shown in FIG. 16. FIG. 16 is a plot of the temperature programmed X-ray diffraction experiment. The black line represents a ramp or hold time. The dashed line represents when diffraction patterns are collected.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

### Additional Embodiments

Additionally or alternately, the invention relates to:

Embodiment 1. A method of thermally stabilizing a metal-organic framework having a plurality of defects comprising the steps of: (a) providing the metal-organic framework, wherein the metal-organic framework has a first PXRD pattern and decomposes after about 12 hours at a first temperature; and (b) contacting the metal-organic framework with a stabilizing solution to provide a treated metal-organic framework, wherein the treated metal-organic framework has a second PXRD pattern substantially the same as the first PXRD pattern, and the treated metal-organic framework is thermally stable at a second temperature after 12 hours at least about 50° C. greater than the first temperature.

Embodiment 2. The method of embodiment 1, wherein the stabilizing solution comprises fluoride ions, in particular wherein the source of fluoride ions is selected from the group consisting of ammonium fluoride, lithium fluoride, cesium fluoride, sodium fluoride, potassium fluoride, and mixtures thereof, preferably ammonium fluoride and/or lithium fluoride, more preferably ammonium fluoride.

Embodiment 3. The method of embodiment 2, wherein the amount of fluoride ions ranges from about 0.5 to 20 mol equivalents relative to the metal-organic framework, and/or wherein the amount of fluoride ions source ranges from about 0.5 to 50 wt. % relative to the metal-organic framework, preferably from about 1 to 30 wt %.

Embodiment 4. The method of embodiment 1, wherein the stabilizing solution comprises an acid selected from the group consisting of carboxylic acids, sulfonic acids, sulfuric acid, phosphonic acids, and mixtures thereof, preferably carboxylic acid or sulfuric acid.

Embodiment 5. The method of embodiment 4, wherein the stabilizing solution comprises a carboxylic acid selected from the group consisting of formic acid, acetic acid, propionic acid, butanoic acid, isobutanoic acid, and mixtures thereof, preferably isobutanoic acid, n-butanoic acid, and/or formic acid, more preferably isobutanoic acid.

Embodiment 6. The method of embodiment 4 or 5, wherein the amount of acid ranges from about 0.5 to 20 mol equivalents relative to the metal-organic framework.

Embodiment 7. The method of any one of the preceding embodiments, wherein at least 5 reflections of the first PXRD pattern are present in the second PXRD pattern.

Embodiment 8. The method of any one of the preceding embodiments, wherein intensity of the reflections of the first PXRD pattern are substantially the same as those in the second PXRD pattern.

Embodiment 9. A method of making a metal-organic framework having improved CO₂ adsorption comprising contacting a metal-organic framework with metal cations and fluoride ions to produce a treated metal-organic framework comprising a non-framework cationic metal species and fluoride.

Embodiment 10. The method of embodiment 9, wherein the source of fluoride ions is selected from the group consisting of ammonium fluoride, lithium fluoride, sodium fluoride, cesium fluoride, potassium fluoride, and mixtures thereof.

Embodiment 11. The method of embodiment 9 or 10, wherein the cationic metal species is a transition metal or an alkali metal.

Embodiment 12. The method of any one of embodiments 9 to 11, wherein the cationic metal species is selected from the group consisting of lithium, sodium, cesium, nickel, cobalt, copper, potassium, and/or silver.

Embodiment 13. The method of any one of embodiments 9 to 12, wherein a metal fluoride is used as a source of fluoride ions and cationic metal species.

Embodiment 14. The method of embodiment 13, wherein the metal fluoride is selected from the group consisting of lithium fluoride, sodium fluoride, potassium fluoride, cesium fluoride, nickel fluoride, silver fluoride, cobalt fluoride, copper fluoride, and mixtures thereof, preferably potassium fluoride, cesium fluoride, nickel fluoride, silver fluoride, cobalt fluoride and/or copper fluoride.

Embodiment 15. The method of embodiment 13 or 14, further comprising contacting with ammonium fluoride.

Embodiment 16. The method of any one of embodiments 9 to 15, wherein the mol ratio of MOF metal to cationic metal species in the mixture ranges from about 3:4 to 24:1, preferably from about 2:1 to 6:1.

Embodiment 17. The method of any one of embodiments 9 to 16, wherein the mol ratio of fluoride ions to cationic metal species in the mixture ranges from about 1:1 to 3:1.

Embodiment 18. The method of any one of the preceding embodiments, wherein the metal-organic framework comprises a plurality of metals selected from aluminum, iron, zirconium, titanium and/or hafnium, preferably zirconium, titanium and/or hafnium.

Embodiment 19. The method of any one of the preceding embodiments, wherein the metal-organic framework comprises metal nodes of zirconium, titanium and/or hafnium.

Embodiment 20. The method of any one of the preceding embodiments, wherein the metal-organic framework is a zirconium-based metal-organic framework, optionally further comprising hafnium and/or titanium, preferably a zirconium-based or zirconium and hafnium-based metal-organic framework.

Embodiment 21. The method of any one of the preceding embodiments, wherein the metal-organic framework comprises Zr₆ metal nodes.

Embodiment 22. The method of any one of the preceding embodiments, wherein the metal-organic framework has a cubic unit cell.

Embodiment 23. The method of any one of the preceding embodiments, wherein the metal-organic framework is selected from EMM-71, UiO-66, UiO-67, UiO-68, MOF 808, zirconium fumarate, or Nu 1000, preferably EMM-71.

Embodiment 24. A metal-organic framework comprising EMM-71 and a moiety selected from the group consisting of formate, acetate, benzoate, propionate, butanoate, isobutanoate, methylsulfonate, ethylsulfonate, propylsulfonate, butylsulfonate, and/or phenylsulfonate, dimethylphosphate, diethylphosphate, dipropylphosphate, dibutylphosphate, diphenylphophate, fluoride, sulfate, or bisulfate; preferably fluoride, isobutanoate, butanoate, and/or formate.

Embodiment 25. The metal-organic framework of embodiment 24, wherein the EMM-71 is Zr-based EMM-71.

Embodiments 26. The metal-organic framework of embodiment 24 or 25, obtainable by the method of any one of embodiments 1 to 8 and 16 to 23.

Embodiment 27. The metal-organic framework of any one of embodiments 24 to 26, comprising fluoride.

Embodiment 28. The metal organic framework of any one of embodiments 24 to 27, further comprising at least one non-framework cationic metal species selected from the group consisting of sodium, lithium, cesium, nickel, cobalt, copper, potassium, silver, and mixtures thereof.

Embodiment 29. The metal-organic framework of embodiment 28, wherein the non-framework cationic metal species is present in an amount, calculated as the atomic ratio of non-framework cationic metal species to MOF metal cations, of at least 0.1, preferably from about 0.1 to 0.65, more preferably from about 0.2 to 0.5.

Embodiment 30. The metal-organic framework of embodiment 28 or 29, obtainable by the method of any one of embodiments 9 to 23.

1-25. (canceled)

26. A method of thermally stabilizing a metal-organic framework having a plurality of defects comprising the steps of:
(a) providing the metal-organic framework, wherein the metal-organic framework has a first PXRD pattern and decomposes after about 12 hours at a first temperature; and
(b) contacting the metal-organic framework with a stabilizing solution to provide a treated metal-organic framework, wherein the treated metal-organic framework has a second PXRD pattern substantially the same as the first PXRD pattern, and the treated metal-organic framework is thermally stable at a second temperature after 12 hours at least about 50° C. greater than the first temperature.

27. The method of claim 26, wherein the stabilizing solution comprises a source of fluoride ions selected from the group consisting of ammonium fluoride, lithium fluoride, cesium fluoride, sodium fluoride, potassium fluoride, and mixtures thereof.

28. The method of claim 27, wherein the amount of fluoride ions ranges from about 0.5 to 20 mol equivalents relative to the metal-organic framework.

29. The method of claim 26, wherein the stabilizing solution comprises an acid selected from the group consisting of carboxylic acids, sulfonic acids, sulfuric acid, phosphonic acids, and mixtures thereof.

30. The method of claim 29, wherein the stabilizing solution comprises a carboxylic acid selected from the group consisting of formic acid, acetic acid, propionic acid, butanoic acid, isobutanoic acid, and mixtures thereof.

31. The method of claim 29, wherein the amount of acid ranges from about 0.5 to 20 mol equivalents relative to the metal-organic framework.

32. The method of claim 26, wherein at least 5 reflections of the first PXRD pattern are present in the second PXRD pattern, wherein intensity of the reflections of the first PXRD pattern are substantially the same as those in the second PXRD pattern.

33. A method of making a metal-organic framework having improved CO₂ adsorption comprising contacting a metal-organic framework with metal cations and fluoride ions to produce a treated metal-organic framework comprising a non-framework cationic metal species and fluoride.

34. The method of claim 33, wherein the source of fluoride ions is selected from the group consisting of ammonium fluoride, lithium fluoride, sodium fluoride, cesium fluoride, potassium fluoride, and mixtures thereof.

35. The method of claim 33, wherein the cationic metal species is a transition metal or an alkali metal selected from the group consisting of lithium, sodium, cesium, nickel, cobalt, copper, potassium, and/or silver.

36. The method of claim 33, wherein a metal fluoride is used as a source of fluoride ions and cationic metal species, wherein the metal fluoride is selected from the group consisting of lithium fluoride, sodium fluoride, potassium fluoride, cesium fluoride, nickel fluoride, silver fluoride, cobalt fluoride, copper fluoride, and mixtures thereof.

37. The method of claim 36, further comprising contacting with ammonium fluoride.

38. The method of claim 33, wherein the mol ratio of MOF metal to cationic metal species in the mixture ranges from about 3:4 to 24:1, and wherein the mol ratio of fluoride ions to cationic metal species in the mixture ranges from about 1:1 to 3:1.

39. The method of claim 26, wherein the metal-organic framework is a zirconium-based metal-organic framework, optionally further comprising hafnium and/or titanium.

40. The method of claim 26, wherein the metal-organic framework is selected from EMM-71, UiO-66, UiO-67, UiO-68, MOF 808, zirconium fumarate, or Nu 1000.

41. The method of claim 33, wherein the metal-organic framework is a zirconium-based metal-organic framework, optionally further comprising hafnium and/or titanium.

42. The method of claim 33, wherein the metal-organic framework is selected from EMM-71, UiO-66, UiO-67, UiO-68, MOF 808, zirconium fumarate, or Nu 1000.

43. A metal-organic framework comprising EMM-71 and a moiety selected from the group consisting of formate, acetate, benzoate, propionate, butanoate, isobutanoate, methylsulfonate, ethylsulfonate, propylsulfonate, butylsulfonate, and/or phenylsulfonate, dimethylphosphate, diethylphosphate, dipropylphosphate, dibutylphosphate, diphenylphophate, fluoride, sulfate, or bisulfate.

44. The metal-organic framework of claim 43, comprising fluoride and at least one non-framework cationic metal species selected from the group consisting of sodium, lithium, cesium, nickel, cobalt, copper, potassium, silver, and mixtures thereof.

45. The metal-organic framework of claim 44, wherein the non-framework cationic metal species is present in an amount, calculated as the atomic ratio of non-framework cationic metal species to MOF metal cations, of at least 0.1.
